(19) United States
(12) Patent Application Publication
(10) Pub. No.: US 2025/0284006 A1
(43) Pub. Date: Sep. 11, 2025

(54) LIDARGRID A 3D OPACITY GRID FROM LIDAR FOR SCENE FORECASTING

(71) Applicant: Honda Motor Co., Ltd., Tokyo (JP)

(72) Inventors: Chuanyu PAN, San Jose, CA (US); Zhihao ZHAO, Sunnyvale, CA (US); Aolin XU, Santa Clara, CA (US)

(73) Assignee: Honda Motor Co., Ltd., Tokyo (JP)

(21) Appl. No.: 18/618,010

(22) Filed: Mar. 27, 2024

Related U.S. Application Data
(60) Provisional application No. 63/562,623, filed on Mar. 7, 2024.

(51) Int. Cl. G01S 17/89; G01S 17/931; G06T 7/521; G06T 17/20

(52) U.S. Cl. CPC G01S 17/89; G01S 17/931; G06T 7/521; G06T 17/20; G06T 2207/10028; G06T 2207/20081

(57) ABSTRACT

A method of forming a three dimensional (3D) opacity grid is provided. The method may map light detection and ranging (LiDAR) points to a grid. The method may employ a volume densification to the grid to generate a 3D opacity grid representing a surrounding scene.

### RELATED APPLICATIONS

This patent application is related to U.S. Provisional Application No. 63/562,623 filed Mar. 7, 2024, entitled “LiDARGrid: 3D Opacity Grid from LiDAR for Scene Forecasting”, in the names of the same inventors which is incorporated herein by reference in its entirety. The present patent application claims the benefit under 35 U.S.C § 119(e) of the aforementioned provisional application.

### BACKGROUND

Contemporary autonomous driving systems may adhere to a two-stage pipeline, first entailing scene comprehension and then motion planning. Both phases may demand a precise, holistic, and efficient encoding of the input information pertaining to the surrounding environment. Traditional methods may perform object detection and pose estimation from camera and light detection and ranging (LiDAR) data, which may heavily rely on the breadth and quality of data annotation. Moreover, these methods may grapple with inherent limitations, such as the depth ambiguity prevalent in camera data or the sparse and unstructured nature of LiDAR data. Consequently, there is a growing endeavor within the research community to develop a scene representation that not only retains the fidelity of scene geometry but may be more compatible with modern neural networks.

Following the camera-based occupancy network, some recent works may incorporate grid-based 3D scene representations. Grid-based 3D scene representations may exhibit promise in various aspects of autonomous systems, which may encompass 3D object detection, segmentation, and scene reconstruction, due to their precision and computational efficiency in modeling the 3D environment. Compared with cameras, LIDAR may have advantages in accurate 3D measurements and robustness to different lighting conditions. However, many of these works may derive their 3D grid representations from camera sensors, leaving the exploration of grid representation from LIDAR data largely uncharted. Furthermore, some may notice that very few of these works delve into scene forecasting, which may take a few historical frames and aims at predicting future frames using certain representations.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method of forming a three-dimensional (3D) opacity grid is provided. The method may map light detection and ranging (LiDAR) points to a grid. The method may employ a volume densification to the grid to generate a 3D opacity grid representing a surrounding scene.

According to another embodiment of the disclosure, a method of forming a three-dimensional (3D) opacity grid, the method implemented using a control system including a processor communicatively coupled to a memory device is provided. The method may initialize a grid by mapping light detection and ranging (LiDAR) points to the grid. The method may employ a volume densification to the grid to generate a 3D opacity grid representing a surrounding scene by filling the LiDAR points having sparse spatial occupancy with a low-dimensional representation space.

According to another embodiment of the disclosure, a method of forming a three-dimensional (3D) opacity grid is provided. The method may initialize a grid by mapping light detection and ranging (LiDAR) points to the grid. The method may further map each LiDAR point to a voxel grid. The method may set a voxel value to a constant σ₀ to initialize a sparse grid of spatial occupancy. The method may employ a volume densification to the grid to generate a 3D opacity grid representing a surrounding scene by filling the LiDAR points having sparse spatial occupancy with a low-dimensional representation space. The method may further use an encoder to map the initialized sparse grid of spatial occupancy into a low dimensional feature vector with a series of convolution layers. The method may further use a decoder to up sample intermediate features with convolution to reconstruct the sparse grid of spatial occupancy to a same size as inputted. The method may remove skip connections between the encoder and decoder layers so only low-frequency signal are passed through.

### BRIEF DESCRIPTION OF THE DRAWINGS

FIG. 1A is an exemplary flow diagram depicting how to generate 3D opacity grid representations (LiDARGrid), in accordance with an embodiment of the disclosure;

FIG. 1B is an exemplary diagram illustrating the efficacy of the LiDARGrid method through scene forecasting tasks, predicting a sequence of future grids from historical grids through a 3D convolutional forecasting network, in accordance with an embodiment of the disclosure;

FIG. 1C is an exemplary diagram illustrating how the LiDARGrid method is used to perform multiple applications, such as point cloud forecasting, movement detection, and depth completion, in accordance with an embodiment of the disclosure;

FIG. 2 shows exemplary images of different visualizations of volume densification, in accordance with an embodiment of the disclosure;

FIG. 3 show exemplary images of visualization of moving region detection, in accordance with an embodiment of the disclosure; and

FIG. 4 shows exemplary images of visualization of depth completion in accordance with an embodiment of the disclosure.

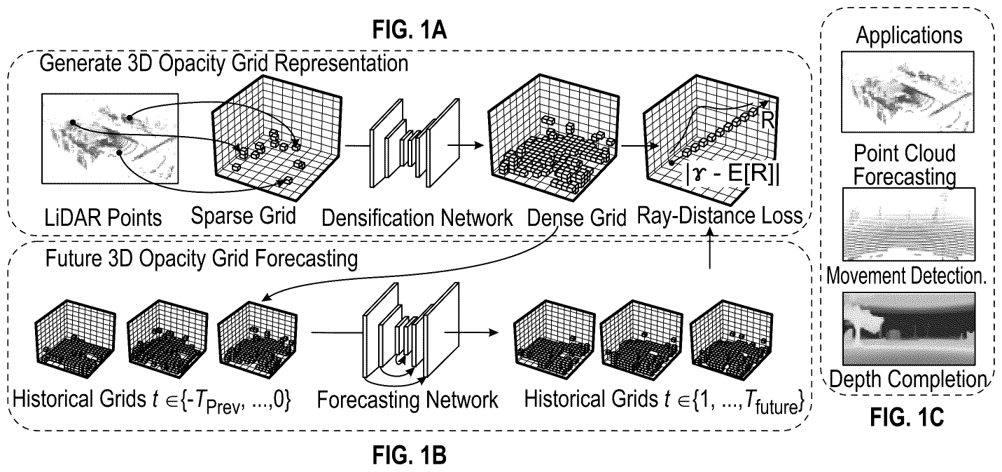

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure provides LiDARGrid, a 3D opacity grid representation derived from LiDAR points. The present system and method may initiate a sparse grid with input LiDAR points, then the system and method may employ a volume densification procedure, together with differentiable volume rendering, and may generate a dense and continuous 3D opacity grid to represent the surrounding scene. Leveraging this representation, one may perform scene forecasting and propose a 3D convolutional network tailored to this task. One may show in the experiments that the present system and method may outperform state-of-the-art methods in point cloud forecasting in all performance metrics. Beyond forecasting, the present system and method may excel in additional applications such as moving region detection and depth completion. Ablation studies may have been conducted to highlight the effectiveness of the present system and method on volume densification and 3D convolution-based scene forecasting.

LiDARGrid may be a dense 3D opacity grid representation from the LiDAR sensor. Motivated by optical models of volume rendering and neural volume rendering, e.g. NeRF, one may conceptualize a representation as a 3D grid, and each voxel may represent the LiDAR opacity, or more precisely, the differential likelihood of a ray stop marching by hitting a particle in it. With grid rendering, one may render the distance from the origin to an object's surface within the grid, thus reconstructing the scene geometry. One may explore the application of this representation in scene forecasting and demonstrate its efficacy through point cloud metrics. A forecasting network may take historical grids as input and predicts future grids. Notably, a network may be trained on unlabeled LiDAR point sequences, adopting a self-supervised approach that may readily facilitate access to a vast pool of training data.

Recent works have been done that may predict future point clouds with grid-based representation and known LiDAR pose. It may show much crisper results than previous point cloud forecasting works with model-free prediction and unknown LiDAR pose, partly because the 3D grid may better preserve scene geometry. Advancing along this direction, the present method and system have two main differences that may contribute to an improved forecasting result: (1) the present system and method may use volume densification, a method that may densify the sparse grid initialized from LiDAR points. The system and method may introduce an autoencoder to map the high-dimensional sparse 3D grid to a low dimensional manifold, and then may decode it to reconstruct a dense grid. Note that the small intermediate feature may be a memory-efficient representation to be stored or transferred. The densified grid on the other hand may be used as a universal representation of the 3D scene for diverse perception and prediction tasks. (2) The system and method may use a 3D convolutional encoder-decoder network optimized for the present 3D grid representation. While one may employ it for forecasting tasks, it may serve as a versatile framework with the potential to incorporate processors for various downstream applications, extending the utility and adaptability of the present method.

Incorporating the above two enhancements, the system and method may achieve state-of-the-art results in scene forecasting tasks, as validated by point cloud metrics. Comprehensive ablation studies may be used to evaluate each module of the system and method. Besides scene forecasting, one may extend the utility of the 3D grid representation to diverse applications, including moving region detection and depth completion. In summary:
1. The system and method may provide a 3D opacity grid representation for various autonomous driving tasks. To acquire a dense and memory-efficient representation, one may introduce volume densification, which densifies the sparse grid input with an autoencoder.
2. The system and method may provide a 3D convolutional forecasting network for the grid representation. The system and method may outperform the current state-of-the-art approaches on point cloud forecasting tasks in all performance metrics.
3. The system and method may provide a comprehensive ablation study that elucidates the efficacy of the system and method, along with demonstrations of its potential in extended applications, such as moving region detection and depth completion.

### 3D Occupancy Grid Scene Representation

The 3D occupancy grid representation has gained increasing attention in recent years. Tesla® introduced a real-time camera-based neural network solution for the 3D occupancy grid in 2022, named occupancy network. The major advantage of such scene representation may be that its accuracy need not be limited by the object-level annotation, which may enable 3D perception of scenes containing unseen and irregular objects, either static or moving. Up-to-date open-sourced studies on occupancy network alternatives may include Surroundocc, TPVforme, OccNet and FBOcc to name a few, all of which may be camera-based.

Conventional LiDAR-based 3D occupancy representations may mainly appear in the 3D mapping and segmentation literature, and are far less studied compared to a large volume of literature on 2D occupancy from range sensors. Most LiDAR-based 3D occupancy may rely on approaches such as kernel methods and graphical models or other Bayesian methods to densify LiDAR point clouds, mostly resulting in a continuous volume representation. LiDAR-based 3D occupancy grids have been done, however, the representation may be solely constructed by placing a point cloud in the grid, hence sparse. The present system and method 3D opacity grid representation may be directly tied to the volume rendering model in computer graphics, where it may be assumed that the space is permeated by particles, and the value of each voxel in the grid may represent the density, proportional to the number, of particles in that voxel. The representation may be constructed by densifying LiDAR point cloud using a carefully tailored neural network, hence dense, and it may be run in real time.

The 3D opacity grid may not be equivalent to a 3D occupancy grid. Instead, it may be more of an intermediate and universal representation of the 3D scene. Nevertheless, as the density of particles reflects the extent to which a voxel is occupied, an opacity grid may be converted to an occupancy grid by thresholding the value of each voxel into a binary value. The quantitative comparison between the 3D opacity grid of a scene generated by the present method and its ground truth 3D occupancy grid may be left as a future study.

Methods of obtaining ground truth 3D occupancy grid from camera and LiDAR have been done in the past. In these works, the moving objects may first be detected and then separated from static backgrounds, so that the LiDAR point clouds on different types of objects may be identified and averaged out differently. In contrast, the present method of opacity grid construction does not rely on object detection at all and may produce a dense opacity grid based on the LiDAR point cloud in the current frame.

### Scene or Occupancy Grid Forecasting

The issue of occupancy grid forecasting may be to predict how the occupancy grid evolves in time. It may arise when the scene contains moving objects. The majority of existing works toward this issue may consider the prediction of 2D dynamic occupancy grid. The prediction of a scene represented by a 3D occupancy grid appears to be a new problem. Different from conventional object-based scene prediction, the occupancy grid prediction in this system and method may be self-supervised, meaning that there is no need to perform object detection and tracking, and unannotated sensor data may be used for prediction.

One may have to distinguish the prediction problem studied in this work, which may be about estimating future scene, from many existing works titled in terms of occupancy grid prediction, which may be about scene completion or estimating occupancy of occluded areas. To this end, one may term the problem under study as opacity grid forecasting.

### Point Cloud Forecasting, 3D Flow, and Moving Region Detection

Point cloud forecasting has also arisen as an issue in computer vision for robotic perception in recent years, as it has the potential to benefit downstream tasks with a large volume of unannotated LiDAR data. Earlier works on this issue may not separate sensor movement from the scene and predict the point cloud in a fully model free manner. The recent work reformulated this issue with a fixed reference frame, but leveraging known sensor pose, and improved the forecasting accuracy by leveraging the 3D occupancy grid representation. The present method proposes new methods for 3D opacity grid construction and forecasting to further improve the performance.

Another advantage of working with LiDAR data may be that the time evolution of the point cloud may provide information on object movement in 3D space. This issue has been studied in the past where an end-to-end framework on point cloud flow may be proposed. Some recent works on 3D occupancy completion and annotation may also take the flow into consideration, by estimating the velocity in 3D of each voxel in the grid. There may be plenty of works on motion estimation from 2D dynamic occupancy grid for an end-to-end learning-based approach and the references therein. In those works, a challenging issue may be the extreme imbalance between static and dynamic cells, and pixel-wise balancing may be applied in the loss function counteracting. One may also propose a solution for moving region detection based on the densified 3D opacity grid, where one may synthesize the point cloud in the previous scene but in the ray directions of the current scene, and detect the distance change of the point cloud which may give hints on a moving region.

### 3D Opacity Grid Representation

Efficiently representing the scene may be important for autonomous driving. In this regard, LiDARGrid may provide a dense 3D opacity grid representation directly acquired from the LiDAR point cloud in real time. This representation may preserve the clear geometry of the surrounding scene and may shows promising results on downstream tasks such as point cloud forecasting and moving object detection.

### Representation Formulation

One's representation of the scene may be inspired by the optical model for volume rendering used in computer graphics. It may be assumed that the 3D space may be permeated by particles that can scatter light, and the density of the particles varies across the space. One may define the representation as a 3D grid of dimension H×W×L with H, W, L being positive integers, which may be scaled by a factor of S∈R to align with the real-world metric in meters. In other words, S may be the voxel size in meters. The origin of the real-world coordinate system may be centered within this grid. The value of a voxel at position (h, w, l)∈{1, . . . , H}×{1, . . . , W}×{1, . . . , L} in the grid, denoted as σ(h, w, l), may represent the density of particles at the real-world point x_{hwl}=(S(w−W/2), S(l−L/2), S(h−H/2)), which may be approximately proportional to the number of particles within that voxel.

This representation may be deterministic, but it may give rise to a simple probabilistic model of LiDAR point rendering: suppose the particles may be uniformly placed at random within each voxel, and independently across voxels, then as the voxel size S decreases to infinitesimal, σ(h, w, l) may become the rate of change of the probability of a LiDAR ray hitting any particle in that voxel. With a normal sized grid, given a ray o+d·r with origin o and direction d, if the ray intersects with a sequence of voxels (v₁, . . . , vₙ) at distance (r₁, . . . , rₙ), the probability of the ray hitting a particle when traveling from vᵢ₋₁ to vᵢ may be derived as:

$${α}_{i} = 1 - exp ( - σ ( {v}_{i} ) \cdot \vert {r}_{i} - {r}_{i - 1} \vert ) . \qquad ( 1 )$$

One may see that σ may essentially represent the opacity of each voxel: the larger the value σ(v), the more likely that a ray stops at voxel v. Hence, one may name the proposed representation as 3D opacity grid. Applying the above probabilistic point rendering model, the distance R that a ray may travel before stopping at a voxel is a random variable, taking value rᵢ with probability:

$${p}_{i} = {α}_{i} \cdot {\prod }_{s = 1}^{i - 1} ( 1 - {α}_{s} ) . \qquad ( 2 )$$

The expected distance of a ray may then be:

$$𝔼 [ R ] = {\sum }_{i = 1}^{n} {p}_{i} \cdot {r}_{i} . \qquad ( 3 )$$

The process of tracing these rays may be likened to simulating LiDAR beams as they traverse through open space and terminate upon encountering an object's surface. Utilizing Equation 3, given the 3D opacity grid, one may compute the expected distance between the starting point and the end point of a LiDAR ray.

Initialize Grid with LiDAR Points

To acquire the 3D opacity grid from LiDAR points, one may first initialize a grid by mapping the LiDAR points to the grid. For a LiDAR point (x, y, z) represented in the real-world coordinate, one may map it to a voxel grid at position (└z/S+H/2┘, └x/S+W/2 ┘, └y/S+L/2┘) and set the voxel value to a constant go. Applying this process to all LiDAR points, one may initialize a sparse grid of spatial occupancy.

### Volume Densification

One may find that simply using the opacity grid initialized from LiDAR points would suffer from its sparsity when performing downstream tasks. Therefore, a volume densification method may be proposed to mitigate this issue. Motivated by the traditional interpolation methods, one may consider this issue as fitting the sparse LiDAR points with a low-dimensional representation space. An intuitive way may be to apply a low-pass filter to the sparse grid, however, it could provide erroneous results when applying volume rendering to calculate distance. To this end, an autoencoder densification network may be designed:

$$\begin{matrix}{V}_{dense} = 𝒟 ( ℰ ( {V}_{sparse} ) ) & {V}_{sparse} , {V}_{dense} ∈\end{matrix} {ℝ}^{H \times W \times L} \qquad ( 4 )$$

The encoder [symbol] (⋅) may map the initialized sparse grid into a low dimensional feature vector with a series of convolution layers, extracting low-frequency information from the input. The decoder [symbol] (⋅) may up sample the intermediate features with convolution to reconstruct the grid to the same size as the input. It should be noted that there may be no skip connections between the encoder and decoder layers to ensure that only low-frequency signal may be passed through the network. One may show in experiments that this may be crucial for the densification performance. The network may be trained in a self-supervised manner with the ray-distance loss:

$$ℒ ( P , {V}_{dense} ) = {\sum }_{o + d \cdot r ∈ P} \vert r - 𝔼 [ R ] \vert \qquad ( 5 )$$

where P may be a set of LiDAR points, r may be the ground-truth distance of a point to the LiDAR origin o. E[R] may be calculated by Equation 3 above and may be differentiable for backpropagation. One may randomly rotate and translate the point cloud as data augmentation to acquire robust densification. The network may eventually learn a pattern to map Vₛₚₐᵣₛₑ to a dense and continuous representation V_{dense} and may generalize to new LiDAR data by training on a small dataset. Furthermore, the small-size intermediate feature vector may be stored as a compressed version of the 3D grid, which may improve the memory and storage efficiency of this representation.
Scene Forecasting with 3D Opacity Grid

One of the remaining challenging issues in autonomous driving is scene forecasting, along with some specific tasks such as point cloud forecasting, video forecasting, etc. One may apply the 3D opacity grid representation to scene forecasting and show that with accurate 3D geometry reconstructed, one may be able to reach better performance on such tasks.

### Problem Definition

The goal of scene forecasting may be to predict how the surrounding scene evolves in the future. Encoding the scene with the above grid representation, the issue may be defined as finding a forecasting model F(⋅), so that

$$( {V}_{t + 1} , … , {V}_{t + {T}_{future}} ) = ℱ ( {V}_{t - {T}_{prev} + 1} , … , {V}_{t} ) \qquad ( 6 )$$

where Vᵢ ∈R^{H×W×L}; Tₚᵣₑᵥ and T_{future} may be the numbers of history frames and future frames respectively. For each frame, one may first transform the LiDAR points from their local sensor coordinate to the coordinate at frame t based on the knowledge of LiDAR pose in each frame. Then one may use the transformed points to initialize and densify the grid as stated above. It may be noted that this coordinate transformation may be optional but may be a reasonable way of using the proposed method in practice.

### Scene Forecasting Network

Enlightened by the success of 2D convolution on image perception, one may regard the present 3D grid representation as a natural extension of the 2D occupancy grid and apply a 3D convolution network to predict future grids. It may preserve local spatial information while extracting important features due to its equivariance. The present scene forecasting network F(⋅) may be a UNET-style 3D convolutional encoder-decoder network. Each pair of corresponding layers in the encoder and decoder with the same feature size may be connected by a skip layer. Following Equation 6 above, the input Dₚᵣₑᵥ ∈R^{Tprev×H×W×L} and output D_{future} ∈R^{Tfuture×H×W×L} may be series of temporal-continuous frames. It may be noted that it may be a general framework that may allow various designs on the intermediate feature layer. For example, one may add LSTM modules to process the latent features. As a baseline model, one may use identity mapping for simplicity.

### Loss Function

An intuitive way to train the network is to use D_{future}=(Vₜ₊₁, . . . , V_{t+Tfuture}) as supervision, where Vᵢ may be generated from the future ground-truth LiDAR points:

$${ℒ}_{voxel} = \sum \vert {D}_{future} - {\hat{D}}_{future} \vert \qquad ( 7 )$$

However, due to high dimensionality, one may observe that the network tends to learn an average result with this loss function because occupancy change on an object's surface may barely affect the overall loss. Therefore, one may propose to use the sparse ground-truth LiDAR points directly as a weaker supervision:

$${ℒ}_{ray} = {\sum }_{i = 1}^{{T}_{future}} ℒ ( {P}_{t + i} , {\hat{V}}_{t + i} ) \qquad ( 8 )$$

where L(Pₜ₊ᵢ, \hat{V}ₜ₊ᵢ) may share the same definition in Equation 5 above, Pₜ₊ᵢ may be the set of LiDAR points at frame t+i. One may compare these two loss functions in the experiment section below.

### Point Cloud Forecasting

The present method may be easily applied to point cloud forecasting tasks. Given future 3D grids (Vₜ₊₁, . . . , V_{t+Tfuture}) and LiDAR rays (o, {dᵢ}), one may simulate future LiDAR points with volume rendering (Equation 1 to Equation 3). One may set (o, {dᵢ}) from ground-truth future LiDAR rays.

### Applications Beyond Scene Forecasting

In addition to scene or point cloud forecasting, the 3D opacity grid representation may be applied to other various tasks. One may describe two additional tasks: moving region detection and depth completion in the experiment section below, and show promising results on both.

### Experiments

### Setup

### Dataset

The experiments were mainly performed on the NuScenes dataset, which is a public autonomous driving dataset containing 1000 driving sequences collected by 6 cameras, 1 LiDAR, and 5 RaDAR sensors. In the experiments, only LiDAR data has been used, which may provide 2 Hz LiDAR sweeps with around 20000 points per frame. One may follow the NuScenes' setting and split the dataset into 850 training scenes and 150 testing scenes. One may train the densification network and forecasting network on the training set and show evaluation results on the testing set.

### Grid and Networks Details

The grid may cover a 4.5 m×70 m×70 m 3D space. Specifically, one may set the grid dimension and size to H=45, W=700, L=700, and S=0.2. Each voxel in the opacity grid may be initialized with 00=1 if it contains a LiDAR point and 0 otherwise. The densification network may contain an encoder with 4 down-sampling layers and a decoder with 4 up-sampling layers. Each down-sampling layer may shrink the grid size by 2 and may double the channel size. Up-sampling layers may reverse this process. The forecasting network may share a similar structure with 3D convolution and skip connections between each pair of encoder-decoder layers.

### Evaluation Metrics

To ensure a rigorous comparison, one may adopt the identical evaluation metrics. Specifically, one may report the in-grid error (L1) and relative in-grid error (AbsRel), measuring the accuracy of distance predictions along LiDAR rays. Additionally, one may employ the vanilla Chamfer distance (Vanilla CD) and in-grid Chamfer distance (In-grid CD) to gauge the spatial distribution error of the predicted point cloud, with measurements expressed in square meters (m²).

Evaluate Scene Forecasting with Point Cloud

### Baselines

One may benchmark the above method against the most recent state-of-the-art approaches in point cloud forecasting, including S2Net, SPFNet, and 4DOcc. Notably, both S2Net and SPFNet may utilize the range map as the scene representation, translating the 3D point cloud into 2D and subsequently employing 2D convolution techniques. 4DOcc may employ a similar grid representation but distinguishes itself by using sparse grids acquired from LiDAR points as input, and further processing them through 2D convolution.

### Quantitative Results

Table 1 below may present a comprehensive comparative analysis between the present method and the baseline models. Notably, the present approach may excel in reducing the average L1 distance error, showcasing an improvement of 0.28 m and 0.21 m for the 1 s and 3 s settings, respectively, when contrasted with the current state-of-the-art. More notably, the present method may demonstrate a reduction in the in-grid Chamfer distance error, achieving a significant improvement of 50% and 29% for the 1 s and 3 s settings, and simultaneously lowering the vanilla Chamfer distance error by 38% and 50% for the same settings. This robust performance may not only attests to the present method's proficiency in predicting the scene's underlying geometry (L1 and AbsRel) but may also underscores its capacity to predict uncorrelated samples (Chamfer Distance), such as point clouds. The present method may achieve this remarkable improvement in Chamfer distance, despite not having employed it as direct training supervision, underscoring the accuracy and robustness of the present approach in predicting future scene geometry.

TABLE 1
Comparison with the state-of-the-art point cloud forecasting methods on NuScenes
Dataset[26]. We follow the evaluation metrics in 4DOcc[8]. The 1 s and
3 s horizons refer to 2 frames and 6 frames respectively, for both input and output.

| Method | Horizon | | L1(m)↓ | AbsRel(%)↓ | In-grid CD↓ | Vanilla CD↓ |
|---|---|---|---|---|---|---|
| S2Net[9] | 1 | s | 3.49 | 28.38 | 1.70 | 2.75 |
| | 3 | s | 4.78 | 30.15 | 2.06 | 3.47 |
| SPFNet[10] | 1 | s | 4.58 | 34.87 | 2.24 | 4.17 |
| | 3 | s | 5.11 | 32.74 | 2.50 | 4.14 |
| 4DOcc[8] | 1 | s | 1.40 | 10.37 | 1.41 | 2.81 |
| | 3 | s | 1.71 | 13.48 | 1.40 | 4.31 |
| Ours | 1 | s | 1.12 | 9.04 | 0.68 | 1.74 |
| | 3 | s | 1.50 | 12.04 | 1.04 | 2.13 |

### Ablation Study

The present method may consist of several key designs that may contribute to the performance of the scene forecasting task, including volume densification, 3D convolutional forecasting network, and its loss function. To comprehensively evaluate the effect of these modules, one may conduct a comprehensive ablation study on them. With or without these modules, one may evaluate the performance of the method on the point cloud forecasting tasks as stated above. One may keep the evaluation metrics, training, and testing datasets the same for clear comparison.

### Opacity Grid Densification

One may argue that inputting dense and geometry-preserved 3D representation to the forecasting network may be essential to the forecasting performance. In this section, one may train and test the present forecasting network with or without volume densification. For the ‘without’ setting, one may simply initialize the grid with LiDAR points as introduced above and input it into the forecasting network.

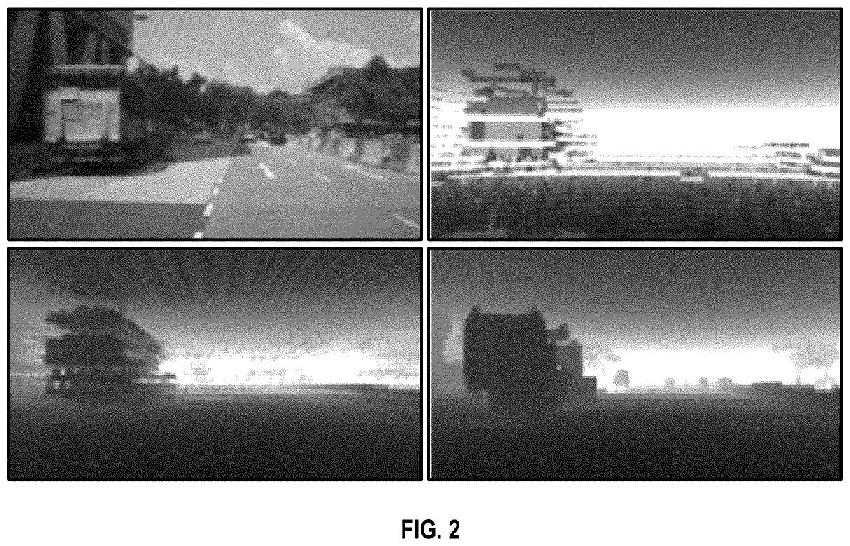

Table 2 below may show the forecasting results with and without volume densification. Upon introducing volume densification, one may observe consistent improvements across all evaluation metrics for both 1 s and 3 s settings. While these enhancements may not be drastic, they may underscore the consistent effectiveness of the volume densification module in enhancing the forecasting task. It is noteworthy that volume densification offers benefits beyond scene forecasting. One may illustrate this through visualizations of the opacity grid, both before (top-right) and after (bottom-right) densification in FIG. 2, revealing a densified 3D grid with fewer holes and a more continuous spatial distribution. This transformation may not only bolster forecasting but may also enhances its applicability to broader tasks, as may be discussed below, such as moving object detection.

TABLE 2
Evaluation results on point cloud forecasting metrics
without and with Volume Densification (VD).

| Method | Horizon | | L1(m)↓ | AbsRel(%)↓ | In-grid CD↓ | Vanilla CD↓ |
|---|---|---|---|---|---|---|
| w/o VD | 1 | s | 1.23 | 9.16 | 0.76 | 1.88 |
| | 3 | s | 1.52 | 12.53 | 1.07 | 2.18 |
| w/VD | 1 | s | 1.12 | 9.04 | 0.68 | 1.74 |
| | 3 | s | 1.50 | 12.04 | 1.04 | 2.13 |

### Densification Network

As may have been stated above, the encoder of the densification network may be a low-pass filter. Since the supervision is sparse, letting high-frequency signals pass through the network may cause overfitting. One may show this by comparing the network with or without skip connections. Specifically, or the network with skip connection:

$${V}_{dense} = 𝒟 ( ℰ ( {V}_{sparse} ) ) + ℳ ( {V}_{sparse} ) \qquad ( 9 )$$

where M(⋅) may be a linear mapping, others share the same definition with Equation 4 above.

FIG. 2 may show that the network with a skip connection may generate grids with holes, where the occupied voxels may be distributed discretely since the network may be overfitting the sparse input. The network without a skip connection may map the input to a low-dimensional manifold and may generate a continuous and dense grid after decoding.

### 2D Convolution vs. 3D Convolution

Some previous works may use 2D convolution in their forecasting network to process intermediate representation. 4DO_{cc} may follow these works and may apply 2D convolution to their 3D representation. One may argue that 3D convolution may be a more suitable operation for the present 3D grid representation than 2D convolution. Therefore, one may conduct experiments to compare these two operations. For 2D convolution, one may follow and reshape the input from size Tₚᵣₑᵥ×H×W×L to (Tₚᵣₑᵥ·H)×W×L.

Table 3 below may illuminate the forecasting results achieved by employing 2D convolution versus 3D convolution within the network. Notably, one may observe a substantial improvement when transitioning from 2D to 3D convolution, particularly evident in the L1 and AbsRel metrics. This marked enhancement may be attributed to the intrinsic ability of the 3D convolution network to effectively extract 3D spatial information, courtesy of its equivariance property and synergy with the 3D grid representation. Furthermore, the 3D convolution framework may afford the capability to process spatial and temporal information separately, thus providing a more versatile platform for the incorporation of modules designed to address temporal consistency-a testament to its broader utility and effectiveness in the forecasting task.

TABLE 3
Evaluation results on point cloud forecasting metrics with
the forecasting network involving 2D and 3D convolution.

| Method | Horizon | | L1(m)↓ | AbsRel(%)↓ | In-grid CD↓ | Vanilla CD↓ |
|---|---|---|---|---|---|---|
| 2D Conv | 1 | s | 1.30 | 10.42 | 0.79 | 1.91 |
| | 3 | s | 1.81 | 15.00 | 1.39 | 2.53 |
| 3D Conv | 1 | s | 1.12 | 9.04 | 0.68 | 1.74 |
| | 3 | s | 1.50 | 12.04 | 1.04 | 2.13 |

### Loss Function

As disclosed above, one may introduce two distinct loss functions, namely Lᵥₒₓₑₗ and L_{ray}, employed in training the forecasting network. In this section, one may delve into a comparative analysis of the performance outcomes associated with these two loss functions. In both scenarios, training may be carried out until convergence is achieved. For the Lᵥₒₓₑₗ setting, one may apply the L1 loss to all voxels within the grid, utilizing the ‘sum’ reduction. The learning rate may be set to 1e-6, with other conditions held constant.

Table 4 below may show the results of applying these two loss functions. One may see that compared to Lᵥₒₓₑₗ, using L_{ray} may reduce the prediction error, on both L1 metric and chamfer distance. It may be because, in areas obstructed from LiDAR rays, small noises may be introduced due to the absence of information in the LiDAR-invisible regions. Employing Lᵥₒₓₑₗ may compel the model to accommodate these inaccuracies, leading to confusion and a tendency to neglect regions with accurate LiDAR supervision. Conversely, the use of L_{ray} may mitigate this issue, which may result in a more accurate and robust forecasting model.

TABLE 4
Evaluation results on point cloud forecasting metrics training with
L1 Voxel Loss [symbol] and Ray-distance Loss [symbol] .

| Method | Horizon | | L1(m)↓ | AbsRel(%)↓ | In-grid CD↓ | Vanilla CD↓ |
|---|---|---|---|---|---|---|
| [symbol] | 1 | s | 2.48 | 23.27 | 1.53 | 2.45 |
| | 3 | s | 3.92 | 41.70 | 3.22 | 4.27 |
| [symbol] | 1 | s | 1.12 | 9.04 | 0.68 | 1.74 |
| | 3 | s | 1.50 | 12.04 | 1.04 | 2.13 |

### Extended Applications

### Moving Region Detection

Through the alignment of two temporally adjacent 3D opacity grids within the same coordinate system, one may enable the detection of moving regions in the grid space—a capability that may hold promise in enhancing driver awareness of unannotated moving objects within the street scene. Specifically, given two LiDAR point clouds Pₜ₋₁ and Pₜ, one may first transform Pₜ₋₁ to Pₜ's local coordinate, then encode them into the present 3D opacity grid representation Vₜ₋₁ and Vₜ as introduced above. For both Vₜ₋₁ and Vₜ, one may cast the same set of rays from a common origin o in a specified direction set dᵢ and may determine the distance between o and the endpoint of each ray, guided by Equation 3 above. By comparing the distances of corresponding rays, should the difference surpass a predetermined threshold ϵ, one may identify the ray as intersecting with a moving object in either Vₜ₋₁ or Vₜ.

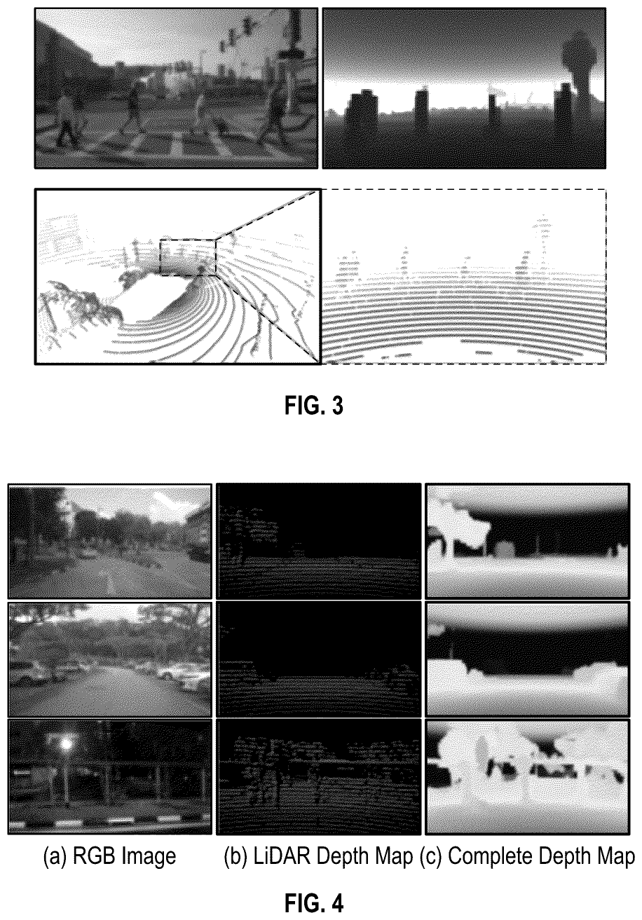

Traditional methods, however, may face challenges in effectively aligning LIDAR rays across consecutive frames due to the stochastic nature of ray directions over time. The present representation, distinguished by its capacity to reconstruct the scene geometry and ensure the uniformity of ray origins and directions in adjacent grids, may overcome this limitation, enabling precise ray alignment, and facilitating the calculation of distance changes. One may show visualization results in FIG. 3, where points on moving pedestrians may be clearly labeled by the present method.

### Depth Completion

Another practical application of the present volume densification method lies in depth completion, which may be a critical task within the realm of autonomous driving. It is worth noting that acquiring dense depth maps in existing camera-LiDAR autonomous driving systems may be cost-prohibitive. Meanwhile, LiDAR sensors may offer only sparse depth maps through the projection of LiDAR points onto a specific view. To address this, the present approach may initiate by creating a sparse grid using LiDAR points, subsequently applying volume densification to transform this grid into a dense 3D opacity grid. This densified grid may allow one to render depth values for each pixel within the grid, following the principles outlined in Equation 1 through 3. FIG. 4 may provide visual insights into the outcomes of the present depth completion process, which shows promising performance in this task.

### CONCLUSION

The above may address the challenge of representing the surrounding scene with only LiDAR input in autonomous driving systems, introducing LiDARGrid—a 3D opacity grid representation from LiDAR sensors—as an efficient solution for encoding unlabeled 3D scene geometry without the need for expensive 3D reconstruction. By initializing a sparse grid with LiDAR points and implementing volume densification, one may create a dense, continuous grid representation with precise geometry. The present approach's effectiveness may be validated through a scene forecasting task, utilizing a UNet-style 3D convolutional forecasting network designed for the present representation. Experimental results may affirm the collective impact of the present representation and the new network on scene forecasting performance. Additionally, the present method may exhibit promising outcomes in diverse downstream tasks, including movement detection and depth completion.

Many interesting aspects may be further developed or investigated from the above. These may include the following items:
In this work, to generate a universal representation of the 3D scene, one may train the densification network independently from the forecasting network; however, many joint training procedures may be possible if the goal is to improve specific downstream tasks;
The conversion of opacity grid to occupancy grid and evaluation of the converted occupancy grid with the ground truth may be important extensions, which may enable more downstream tasks to be carried out directly from the proposed representation, e.g. motion planning;
The current running speed of the proposed pipeline may be 5 frames per second, which may almost support real-time applications. Further improvements may be largely gained from network optimization and CUDA acceleration.

Looking forward, one may envision the proposed 3D opacity grid representation as a central element of a versatile pipeline capable of processing multiple types of sensor inputs including both LiDAR and camera data, performing tasks spanning perception, understanding, forecasting, and beyond.

A system and method, LiDARGrid, may be disclosed above. LiDARGrid may be a 3D opacity grid representation derived from LiDAR points. The system and method may initiate a sparse grid with input LiDAR points, then it may employ a novel volume densification procedure, together with differentiable volume rendering, generates a dense and continuous 3D opacity grid to represent the surrounding scene. Leveraging this representation, one may perform scene forecasting and propose a 3D convolutional network tailored to this task. It may be shown in the experiments that the system and method may outperform state-of-the-art methods in point cloud forecasting in all performance metrics. Beyond forecasting, the system and method may excel in additional applications such as moving region detection and depth completion. Comprehensive ablation studies may have been performed, to highlight the effectiveness of the proposed system and methods on volume densification and 3D convolution-based scene forecasting.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method of forming a three-dimensional (3D) opacity grid comprising:
mapping light detection and ranging (LiDAR) points to a grid;
employing a volume densification to the grid to generate a 3D opacity grid representing a surrounding scene.

2. The method of claim 1, wherein mapping the LiDAR points to a grid comprises:
mapping each LiDAR point to a voxel grid; and
setting a voxel value to a constant go to initialize a sparse grid of spatial occupancy.

3. The method of claim 1, wherein employing a volume densification comprises filling the LiDAR points having sparse spatial occupancy with a low-dimensional representation space.

4. The method of claim 1, wherein employing a volume densification comprises:
using an autoencoder to map the LiDAR points having sparse spatial occupancy to a low dimensional manifold; and
decoding the low dimensional manifold to reconstruct the 3D opacity grid representing the surrounding scene.

5. The method of claim 3, wherein employing a volume densification comprises:
using an encoder to map the initialized sparse grid of spatial occupancy into a low dimensional feature vector with a series of convolution layers; and
using a decoder to up sample intermediate features with convolution to reconstruct the sparse grid of spatial occupancy to a same size as inputted.

6. The method of claim 5, comprising extracting low-frequency information from the initialized sparse grid of spatial occupancy.

7. The method of claim 5, comprising removing skip connections between the encoder and decoder layers so only low-frequency signal are passed through.

8. The method of claim 4, comprising randomly rotating and translating the LiDAR points.

9. The method of claim 1, comprising using a forecasting network to take historical 3D opacity grids as input to predict future 3D opacity grids.

10. The method of claim 9, wherein the forecasting network transforms each LIDAR point from a local sensor coordinate to a coordinate at frame t based on LiDAR pose in each frame.

11. The method of claim 9, wherein the forecasting network is a UNET-style 3D convolutional encoder-decoder network, wherein each pair of corresponding layers in the encoder-decoder network with the same feature size is connected by a skip layer.

12. A method of forming a three-dimensional (3D) opacity grid, the method implemented using a control system including a processor communicatively coupled to a memory device, the method comprising: comprising:
initializing a grid by mapping light detection and ranging (LiDAR) points to the grid; and
employing a volume densification to the grid to generate a 3D opacity grid representing a surrounding scene by filling the LiDAR points having sparse spatial occupancy with a low-dimensional representation space.

13. The method of claim 12, wherein mapping the LiDAR points to a grid comprises:
mapping each LiDAR point to a voxel grid; and
setting a voxel value to a constant go to initialize a sparse grid of spatial occupancy.

14. The method of claim 12, wherein employing a volume densification comprises:
using an autoencoder to map the LiDAR points having sparse spatial occupancy to a low dimensional manifold; and
decoding the low dimensional manifold to reconstruct the 3D opacity grid representing the surrounding scene.

15. The method of claim 12, wherein employing a volume densification comprises:
using an encoder to map the initialized sparse grid of spatial occupancy into a low dimensional feature vector with a series of convolution layers; and
using a decoder to up sample intermediate features with convolution to reconstruct the sparse grid of spatial occupancy to a same size as inputted.

16. The method of claim 15, comprising extracting low-frequency information from the initialized sparse grid of spatial occupancy.

17. The method of claim 15, comprising removing skip connections between the encoder and decoder layers so only low-frequency signal are passed through.

18. The method of claim 12, comprising randomly rotating and translating the LIDAR points.

19. The method of claim 12, comprising using a forecasting network to take historical 3D opacity grids as input to predict future 3D opacity grids.

20. A method of forming a three-dimensional (3D) opacity grid comprising:
initializing a grid by mapping light detection and ranging (LiDAR) points to the grid, wherein mapping the LiDAR points to a grid comprises:
mapping each LiDAR point to a voxel grid; and
setting a voxel value to a constant go to initialize a sparse grid of spatial occupancy;
employing a volume densification to the grid to generate a 3D opacity grid representing a surrounding scene by filling the LiDAR points having sparse spatial occupancy with a low-dimensional representation space, wherein employing a volume densification comprises:
using an encoder to map the initialized sparse grid of spatial occupancy into a low dimensional feature vector with a series of convolution layers; and
using a decoder to up sample intermediate features with convolution to reconstruct the sparse grid of spatial occupancy to a same size as inputted; and
removing skip connections between the encoder and decoder layers so only low-frequency signal are passed through.
